(19) United States
(12) Patent Application Publication
(10) Pub. No.: US 2011/0145426 A1
(43) Pub. Date: Jun. 16, 2011

(54) NETWORKING METHOD OF COMMUNICATION APPARATUS, COMMUNICATION APPARATUS AND STORAGE MEDIUM

(75) Inventors: Akira Miyajima, Fukuoka (JP); Hirokazu Hayata, Fukuoka (JP); Hiroyuki Shimooosawa, Fukuoka (JP)

(73) Assignee: PANASONIC CORPORATION, Osaka (JP)

(21) Appl. No.: 12/963,441

(22) Filed: Dec. 8, 2010

(30) Foreign Application Priority Data
Dec. 10, 2009 (JP) 2009-280560

(51) Int. Cl. G06F 15/16

(52) U.S. Cl. 709/230

(57) ABSTRACT

In a networking method of a communication apparatus in which global address information and port information are acquired on a network, a virtual private network is established with another communication apparatus using the global address information and the port information to perform the communication, the networking method includes determining whether communication data that is transmitted from the communication apparatus is a first protocol or a second protocol, and starting a data transmission through the network before the virtual private network is established when the communication apparatus determines that the communication data is the first protocol, and starting a data transmission after the virtual private network is established when the communication apparatus determines that the communication data is the second protocol.

### BACKGROUND

1. Technical Field

The present invention relates to a networking method of a communication apparatus, a communication apparatus, a program and a storage medium in a VPN (Virtual Private Network) technology that connects between networks or the like using a communication network in which a plurality of subscribers commonly uses a band instead of a leased communication line (a leased line) by which a network communication is performed with a specific communication partner.

2. Background Art

A virtual private network (hereinafter, referred to as a VPN) generally connects between different network segments for example, between two or more locations of local area networks (a LAN) within a company or the like through a wide area network (WAN) or the like. Thus, the communication secrecy is guaranteed and then all networks configure so as to be as one private network (as the leased line) virtually. Accordingly, the communication service can be provided in the same manner as the utilization of the leased line.

As such the VPN is generally divided into an Internet VPN that is established using the WAN or a public line network such as the Internet and IP-VPN that is established using a communication network that is different from the Internet or the like of a communication common carrier's closed area network or the like. Specifically, the number of users of the Internet VPN is increasing since recent networking infrastructure becomes broadband and the VPN can be established using the Internet at low cost.

To establish the VPN, for example, in a case where the communication is performed between different locations, a common communication network such as the Internet is interposed along the communication path. Therefore, there are risks of communication leakage, wiretapping, impersonation or the like. Thus, in the VPN technology, encrypting and encapsulating the data are basic technical considerations in any one of layers of the network so as to guarantee the secrecy of the communication. It is called as “encapsulation (or encapsulating)” that a communication protocol is packed and transmitted in a packet of another communication protocol.

As specific examples of encryption protocol that is used in VPN technology, an IPsec (Internet Protocol Security Architecture) in which the encryption is performed in the IP (Internet Protocol) layer, an SSL (Secure Socket Layer) in which the encryption is performed in a TCP (Transmission Control Protocol) layer (specifically, used in HTTP: Hyper Text Transfer Protocol) or the like are well known. Also, a SSH (Secure SHell), a TLS (Transport Layer Security), a SoftEther, a PPTP (Point-to-Point Tunneling Protocol), an L2TP (Layer 2 Tunneling Protocol), an L2F (Layer 2 Forwarding), an MPLS (Multi-Protocol Label Switching) or the like are known as other VPN technology. In a software program VPN that establishes the VPN by the software program, a tunneling technique that uses the IPsec or the SSL is used. It is called as “tunneling” that a communication protocol is communicated as the data of the same or upper layer protocol. In a case where the VPN is established, the packet is encrypted and encapsulated so that a virtual tunnel is established by the VPN apparatus that is provided in the terminal or the like (hereinafter, referred to as a “peer”) that performs the communication or a relay apparatus of the network. Accordingly, the closed communication path that connects between the peers is established.

For example, as the technology to interconnect the networks, the communication path is established using a reverse tunnel technique. A communication path maintenance data is transmitted so as to maintain the communication path and an electronic signature or encryption is performed so as to prevent communication leakage (for example, see JP-A-2008-160497).

However, in a case where the communication path (here, description will be given using a P2P (a Peer-to-Peer) communication path as an example) is established using a plurality of VPN apparatus, a connection request is transmitted toward the VPN apparatus of the communication destination with which any VPN apparatus desires to communicate. The VPN apparatus that receives the connection request transmits a connection response with respect to the connection request toward the VPN apparatus of the transmission source. Thus, it is determined whether the P2P communication is possible between the VPN apparatuses. In a case where the P2P communication is possible, the P2P communication path is established and then the transmitting/receiving of the communication data becomes possible.

As the communication format of the communication performed by the VPN apparatus that establishes the P2P communication path, there are a communication by a TCP (Transmission Control Protocol) (hereinafter, referred to as a TCP communication) and a communication by a UDP (User Datagram Protocol) (hereinafter, referred to as a UDP communication). The TCP communication which is a communication format of a connection type, has a high reliability, secures the data communication and then is a communication type that does not need real time performance. Meanwhile, the UDP communication is a communication format of a connectionless type, is used in the communication that require high real time performance, does not secure the data communication and then is a communication type that has a low reliability.

Also, the TCP packet (the TCP data) is transmitted/received in the TCP communication, and the UDP packet (the UDP data) is transmitted/received in the UDP communication. The TCP packet is mainly used in a packet in which high reliability is needed such as a packet for the data communication and a packet for control, and the UDP packet is mainly used in a packet in which real time performance is needed such as a packet for the image communication and a packet for voice communication or the like. TCP and UDP packets are transmitted and received at the same time in some eases. Generally, in the packet transmission when communication is performed, when these packets are transmitted/received in a burst manner, the load of the VPN apparatus and the system are increased temporarily, and a communication delay, a communication failure or the like occur. Accordingly, it is preferable that a priority sequence of the data to be transmitted/received is determined according to the type of the packet in the process in which the packets are transmitted in a burst manner so as to avoid the occurrence of the failure as much as possible.

The invention has been made in view of the above-described situation and an object of the invention is to provide the networking method of the communication apparatus, the communication apparatus, the program and the storage medium in which the communication delay and the communication failure can be constrained to a minimum with respect to the bursty packet that is generated when the VPN communication is established between the plurality of the VPN apparatuses.

### SUMMARY

A networking method of a communication apparatus, for performing communication by acquiring global address information and port information on a network, and by establishing a virtual private network with another communication apparatus using the global address information and the port information, includes the steps of: determining a protocol type of communication data that is transmitted from the communication apparatus, and starting a data transmission through the network before the virtual private network is established when the communication apparatus determines that the protocol type is a first protocol, and starting the transmission after the virtual private network is established when the communication apparatus determines that the protocol type is a second protocol.

According to the configuration, the communication delay and the communication failure can be constrained to a minimum when the VPN communication is established in a case where the communication is performed between a plurality of the communication apparatuses.

### BRIEF DESCRIPTION OF THE DRAWINGS

In the accompanying drawings:

FIG. 1 illustrates a configuration example of a VPN system according to an embodiment of the invention;

FIG. 2 is a block diagram illustrating a configuration example of a hardware configuration of a VPN apparatus according to the embodiment of the invention;

FIG. 3 is a block diagram illustrating a functional configuration example of the VPN apparatus according to the embodiment of the invention;

FIG. 4 is a flowchart illustrating an example of a process sequence when determining the type of communication packet in the VPN system according to the embodiment of the invention;

FIG. 5 is a sequence diagram illustrating a process sequence when establishing the VPN in a case of detecting a TCP packet in the VPN system according to the embodiment of the invention;

FIG. 6 is a sequence diagram illustrating a process sequence when establishing the VPN in a case of detecting a UDP packet in the VPN system according to the embodiment of the invention;

FIG. 7 is a sequence diagram illustrating another process sequence when establishing the VPN in a case of detecting a UDP packet in the VPN system according to the embodiment of the invention;

FIG. 8 is a flowchart illustrating process details when establishing the VPN in a case of detecting the TCP packet in the VPN apparatus according to the embodiment of the invention;

FIG. 9 is a flowchart illustrating process details when establishing the VPN in a case of detecting the UDP packet in the VPN apparatus according to the embodiment of the invention;

FIG. 10 is a flowchart illustrating other process details when establishing the VPN in a case of detecting the UDP packet in the VPN apparatus according to the embodiment of the invention;

FIG. 11 illustrates a modified configuration example of the VPN system according to the embodiment of the invention; and

FIG. 12 is a block diagram illustrating a modified functional configuration example of the VPN apparatus according to the embodiment of the invention.

### DETAILED DESCRIPTION OF THE EXEMPLARY EMBODIMENTS

Below, an embodiment as an example of a VPN apparatus, a VPN networking method, a program and a storage medium will be described. Here, a configuration example is described in a case where a virtual private networking (VPN) system is established by connecting two local area network (LAN, local network) paths through wide area network (WAN, global network). As the LAN, a wired LAN or wireless LAN may be used. As the WAN, the Internet or the like is used.

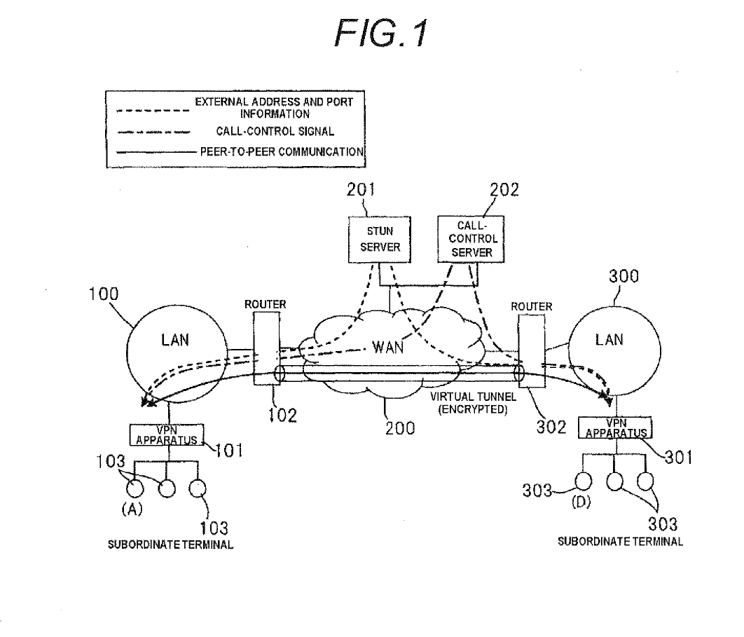

FIG. 1 illustrates a configuration example of a VPN system according to the embodiment of the invention. The VPN system of the embodiment establishes a communication path between the LAN 100 that is provided in one location and the LAN 300 that is provided in another location through the WAN 200 such as the Internet. Thus, a communication (also referred to as “VPN communication”) in which security is guaranteed by the VPN between the terminals 103 that are connected under the LAN 100 and the terminals 303 that are connected under the LAN 300 can be performed. An IP telephone (a voice telephone), a net meeting (a moving picture and a voice communication), a network camera (a video transmission) or the like are assumed as specific purposes (application programs or the like) of the VPN communication.

A router 102 is provided at a boundary between the LAN 100 and the WAN 200, and a router 302 is provided at a boundary between the WAN 200 and the LAN 300. In the embodiment, the VPN apparatus 101 is connected to the LAN 100 and the VPN apparatus 301 is connected to the LAN 300 so as to establish the VPN connection. Accordingly, the subordinate terminal 103 is connected under (is under control of) the VPN apparatus 101 and the subordinate terminal 303 is connected under (is under control of) the VPN apparatus 301.

Also, an STUN server 201 and a call-control server 202 are connected to the WAN 200 so as to connect by VPN (hereinafter, referred to as “VPN connection”) between the VPN apparatus 101 and the VPN apparatus 301. The STUN server 201 is a server that is used to perform STUN (Simple Traversal of User Datagram Protocol (UDP) through Network Address Translators (NATs)) protocol. The call-control server 202 is a server that is used for outgoing calls and incoming calls between peers such as VPN apparatuses, terminals or the like.

In FIG. 1, a broken line indicates flow of external address and port information including information of an external address (a global IP address) and port. Also, one dot chain line indicates a flow of call-control signal regarding a control of outgoing calls and incoming calls. The solid line indicates a flow of Peer-to-Peer communication (P2P communication) regarding communication data that is transmitted between peers. Furthermore, a communication path that is connected to the VPN for P2P communication is indicated as a virtual tunnel in FIG. 1.

In the case where each of devices communicates through the WAN 200, global address information that can be specified in the WAN is used on the WAN 200 as the address information for specifying a transmission source and a transmission destination of a packet to be transmitted. Generally, since the IP network is used, the global IP address and the port number are used. However, in the communication in each of LANs 100 and 300, the local address information that specifies only in the LAN, are used as the address information for specifying the transmission source and the transmission destination. Generally, since the IP network is used, the local IP address and the port number are used. Thus, a NAT (Network Address Translation) function that performs a conversion between the local address information and the global address information is incorporated in each of the routers 102 and 302 so as to allow the communication between each of LANs 100 and 300 and the WAN 200. In the case of networks other than the IP network, the global address information other than the global JP address may be allowed.

In each of the terminals under the LANs 100 and 300, the terminal does not have the global IP address information accessible from the external. The terminal 103 under the LAN 100 does not directly communicate with terminal 303 under the other LAN 300, if a specific setting is not performed. Also, usually, each of the terminals within each of the LANs 100 and 300 cannot be accessed from the WAN 200 side due to the NAT function of each of the routers 102 and 302.

Even in this situation, the VPN apparatuses 101 and 301 are provided in the LAN of each of the locations in the embodiment, so that the VPN connection is established between the LANs and then the direct communication can be performed through the communication path that is virtually closed between the terminal 103 and the terminal 303 as the path of P2P communication shown in the solid line in FIG. 1. The configuration, the function and the operation of the VPN apparatus according to the embodiment will be described in sequence below.

The STUN server 201 performs a service regarding the performance of STUN control, that is an address information server that supplies necessary information to perform communication beyond the NAT. The STUN is a client server type Internet protocol that is standardized as one method of the NAT traversal in the application that performs bi-directional real time IP communication such as voice, image, sentence or the like. The STUN server 201 returns the external address and port including the information of the global IP address and port which can be seen from the external network as the global address information of the access source that is capable of accessing from the external according to the request from the access source. As the external address and port information, the global IP address of an IP network layer and the port number of a transport layer are used in the IP network.

Each of the VPN apparatuses 101 and 301 performs the communication of predetermined test sequence with the STUN server 201 and receives a response packet that includes the port number and the global IP address of the own apparatus from the STUN server 201. Accordingly, each of the VPN apparatuses 101 and 301 can obtain the port number and the global IP address of the own apparatus. Also, even in a case where a plurality of routers is present between the LAN and the WAN in which the own apparatus is positioned, or even in a case where the routers do not have a function of UPnP (Universal Plug and Play), it has an effect that the global IP address and the port number can be reliably obtained.

Regarding a method in which the VPN apparatuses 101 and 301 obtain the global IP address and the port number, a method described in the RFC 3489 (STUN) of IETF can be used. However, in the method according the STUN only the global IP address and the port number can be obtained, and in the embodiment, the VPN can be easily and flexibly established without performing a previous setting work of various parameters before the communication.

The call-control server 202 is a call management server that performs a service regarding a call-control between the communication apparatuses for calling a specific partner and establishing a communication path. The call-control server 202 stores identification information of the registered VPN apparatus or the terminal, and in the case of a communication system that has a function of the IP telephone for example, it is also assumed that the specific partner is called based on a telephone number of the connecting partner. Also, the call-control server 202 has a function that relays a signal or data and may transmit the packet that is sent from a transmission apparatus to a reception apparatus or may transmit the packet that is sent from the reception apparatus to the transmission apparatus.

Also, the STUN server 201 and the call-control server 202 are described as an example configured as separated servers. However, two server functions that consist of the address information server and the relay server may be loaded and configured in one server and the same function may be loaded and configured in another server on the WAN.

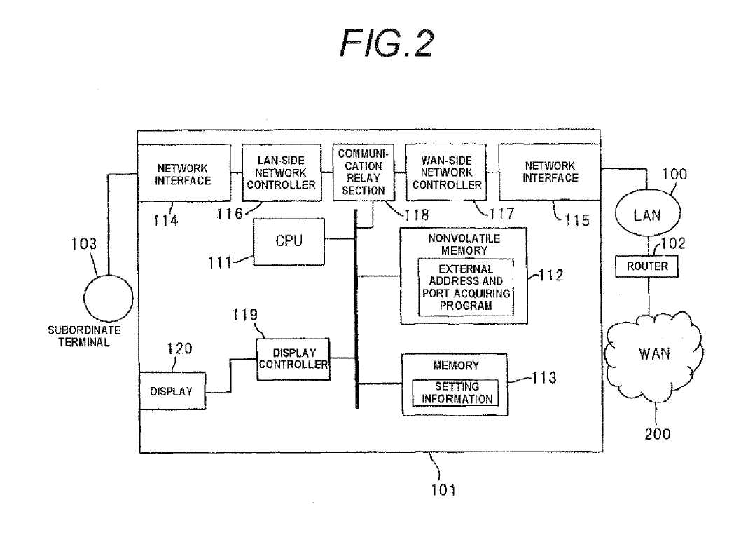

Next, the configuration and the function of the VPN apparatus according to the embodiment will be described. The configuration and the function of the VPN apparatus 101 and the VPN apparatus 301 are the same and here, the VPN apparatus 101 will be described. FIG. 2 is a block diagram illustrating a configuration example of a hardware configuration of a VPN apparatus according to the embodiment.

The VPN apparatus 101 includes a central processing unit (CPU) 111, a nonvolatile memory 112 such as a flash RAM (Random Access Memory), a memory 113 such as a RAM, a network interface 114, a network interface 115, a Lan-side network controller 116, a Wan-side network controller 117, a communication relay section 118, a display controller 119 and a display 120.

The CPU 111 performs an overall control of the VPN apparatus 101 by practicing a predetermined program. The nonvolatile memory 112 stores a program that is performed by the CPU 111. In the program, an external address and port acquiring program is also included in which the VPN apparatus 101 acquires the external address and port information.

Regarding the program that is performed by the CPU 111, it may be acquired from the external server by online through a communication path or may be acquired by reading a storage medium such as a memory card or CD-ROM, for example. In other words, the general-purpose computer reads the program that realizes the function of the VPN apparatus from the storage medium so that the VPN apparatus and the VPN networking method can be realized.

When the CPU 111 performs the programs, some of the programs on the nonvolatile memory 112 are loaded on the memory 113 and the programs on the memory 113 may be executed.

The memory 113 is provided for temporally storing a data management during operation of the VPN apparatus 101, various setting information or the like. As the setting information, the external address and port information that are included in a response of a request of the external address and port acquirement of the terminal and destination address information that are necessary for the communication are included.

The network interface 114 is an interface that connects the VPN apparatus 101 and the subordinate terminal 103 that is managed under the VPN apparatus 101, and thus enable communication. The network interface 115 is an interface that connects the VPN apparatus 101 and the LAN 100 to enable communication. The Lan-side network controller 116 performs the communication control regarding the Lan-side network interface 114. The Wan-side network controller 117 performs the communication control regarding the Wan-side network interface 115.

The communication relay section 118 relays packet data that is sent to the external VPN connection destination (the terminal 303 under control of the VPN apparatus 301) from the terminal 103 connected under the Lan-side and, reversibly, packet data that is arrived at the terminal 103 under the external VPN connection destination (the terminal 303 under control of the VPN apparatus 301) respectively.

The display 120 includes a display device that displays the operation state of the VPN apparatus 101 and informs various states to a user or a manager. The display 120 includes a plurality of light emitting diodes (LED), liquid crystal display (LCD) or the like. The display controller 119 performs a display control of the display 120 so as to control the contents that are displayed on the display 120 according to display signal from the CPU 111.

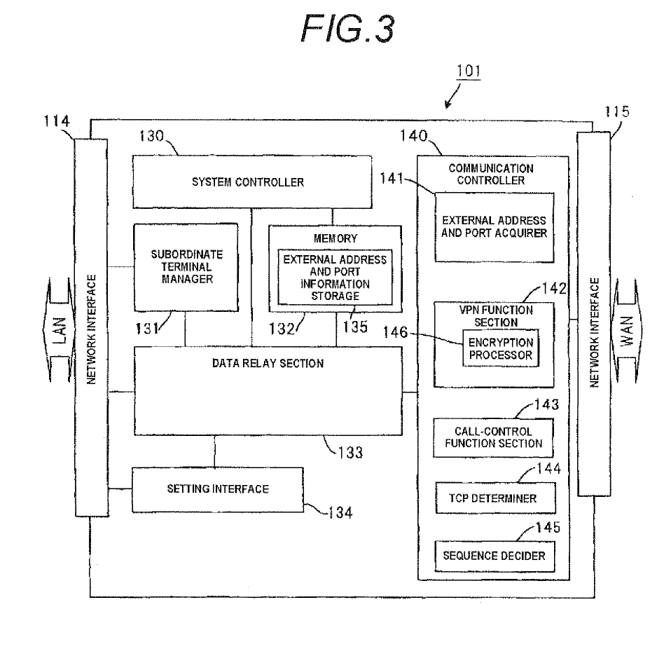

FIG. 3 is a block diagram illustrating a functional configuration example of the VPN apparatus according to the embodiment.

The VPN apparatus 101 includes as a functional configuration, a system controller 130, a subordinate terminal manager 131, a memory 132, a data relay section 133, a setting interface 134 and a communication controller 140. The memory 132 has an external address and port information storage 135. The communication controller 140 includes an external address and port acquirer 141, a VPN function section 142, a call-control function section 143, a TCP determiner 144 and a sequence decider 145. The VPN function section 142 has an encryption processor 146. Each of the functions is realized by the operation of the hardware of each of the blocks shown in FIG. 2 or by the CPU 111 performing a predetermined program.

The Lan-side network interface 114 of the VPN apparatus 101 is connected to the subordinate terminal 103 and the Wan-side network interface 115 is connected to the WAN 200 through the LAN 100 and the router 102.

The system controller 130 performs overall control of the VPN apparatus 101. The subordinate terminal manager 131 performs the management of the terminal 103 being under control of the VPN apparatus 101. The memory 132 stores the external address and port information that includes the information of the external address (the global IP address on the WAN 200) and port (the port number of the IP network) in the external address and port information storage 135. As the external address and port information, the information of the global IP address and the port number assigned to the subordinate terminal 103 that is the connection source or the information of the global IP address and the port number assigned to the terminal 303 that is the connection destination are stored.

The data relay section 133 relays (receives/transmits) the packet that is sent to the terminal 303 of the connection destination from the terminal 103 of the connection source or reversely the packet that is sent to the terminal 103 of the connection source from the terminal 303 of the connection destination respectively. In other words, the data relay section 133 realizes each of functions of a communication data receiver that receives the communication data from the subordinate terminal and a communication data transmitter that transmits the communication data. The setting interface 134 is a user interface in which the user or the managing person performs various operations such as setting operation or the like with respect to the VPN apparatus 101. As a specific example of the user interface, Web page or the like that is displayed by a browser that is operated on the terminal is used.

The external address and port acquirer 141 of the communication controller 140 acquires the external address and port information that are assigned to the terminal 103 being under control of the VPN apparatus 101 from the STUN server 201. Also, the packet that includes the external address and port information of the terminal 303 of the connection destination is received through the call-control server 202 and the external address and port information that are assigned to the terminal 303 of the connection destination are acquired. The information that is acquired by the external address and port acquirer 141 is stored in the external address and port information storage 135 of the memory 132.

The VPN function section 142 of the communication controller 140 performs an encryption process that is necessary for the VPN communication in the encryption processor 146. In other words, the encryption processor 146 performs encapsulating and encrypting the packet to be transmitted or decapsulating and decrypting the received packet, and then the original packet is extracted. The VPN communication performs the relay of the packet not in the P2P communication shown in FIG. 1 but in the server that is provided on the WAN 200, and may perform the VPN communication in a client/server type. In this case, the encryption process may be performed at the server side. The communication controller 140 determines whether the P2P communication is possible or not. Information for specifying the terminal 103 under the own apparatus or information for specifying the terminal 303 being under control of the partner apparatus are included in the packet that are encapsulated. The communication data are relayed by the data relay section 133 between the VPN apparatus and the terminals under the VPN apparatus based on the specific information. Also, the determination of whether the P2P communication is possible or not is an example of determining whether the VPN communication is possible or not.

The call-control function section 143 of the communication controller 140 performs a process in which a connection request for connecting to the connection destination as a target is transmitted to the call-control server 202 or a connection response from the connection destination is received through the call-control server 202.

The TCP determiner 144 of the communication controller 140 detects the communication packet (the communication data) that is relayed by the data relay section 133. Thus, it determines the type of the communication data to be relayed by the data relay section 133. Specifically, the transmitting communication packet is identified as the TCP packet (the TCP data) or the UDP packet (the UDP data).

The sequence decider 145 of the communication controller 140 decides a priority order in which a predetermined process is performed based on the determination result by the TCP determiner 144. Specifically, the VPN function section 142 decides the sequence of whether the P2P communication is possible or not and the transmission start of the communication data by the data relay section 133. In a case where the TCP determiner 144 determines that the communication packet is the UDP packet, the sequence decider 145 starts the transmission of the communication packet before the determination of whether the P2P communication is possible or not. On the one hand, in a case where the TCP determiner 144 determines that the communication packet is the TCP packet, the sequence decider 145 starts the transmission of the communication packet after the determination of whether the P2P communication is possible or not, or after decision of communication path. Since the transmission of the communication packet starts after decision of communication path, a load toward the call-control server 202 can be decreased.

In other words, the communication controller 140 realizes each of the functions of the external address and port information acquirer that acquires the external address and port information of the VPN apparatus 101, the external address and port information transmitter that transmits the external address and port information of the VPN apparatus 101, and the external address and port information receiver that receives the external address and port information of the partner apparatus. Also, the communication controller 140 establishes the communication path of the VPN communication and realizes each of the functions of the communication state determiner that determines whether the P2P communication is possible or not, the data type deter miner that determines the type of communication data, and the sequence decider that decides the sequence of the determination of whether the P2P communication is possible or not and the transmission start of the communication data.

As described above, the TCP determiner 144 and the sequence decider 145 are included, so that, according to the type of the communication packet to be transmitted by the VPN apparatus 101, the sequence of the determination of whether the P2P communication is possible or not and the transmission start of the communication data can be determined and the packet (the protocol) that starts the communication preferentially can be selected even during the process of the determination of whether the P2P communication is possible or not. In a case of occurrence of the bursty packet, the packet can be suppressed, so that a load that is generated at the server that relays the communication packet can be decreased and a communication delay when the communication starts and the communication failure can be held in minimum.

Next, an operation when the VPN connection is established by the VPN apparatus 101 according to the embodiment will be described.

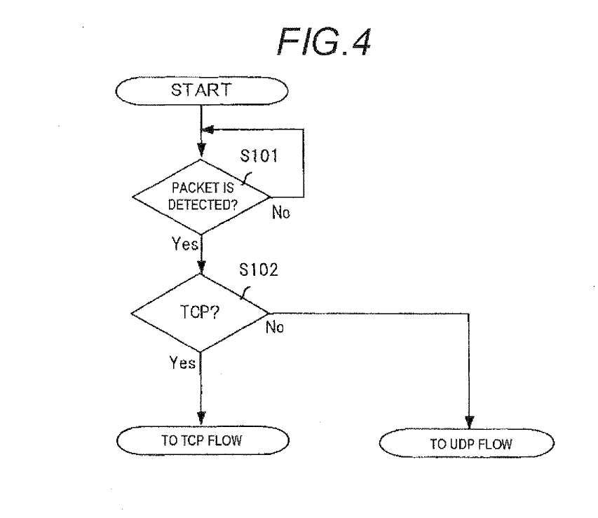

FIG. 4 is a flowchart illustrating an example of a sequence when determining the type of communication packet in the VPN system according to the embodiment.

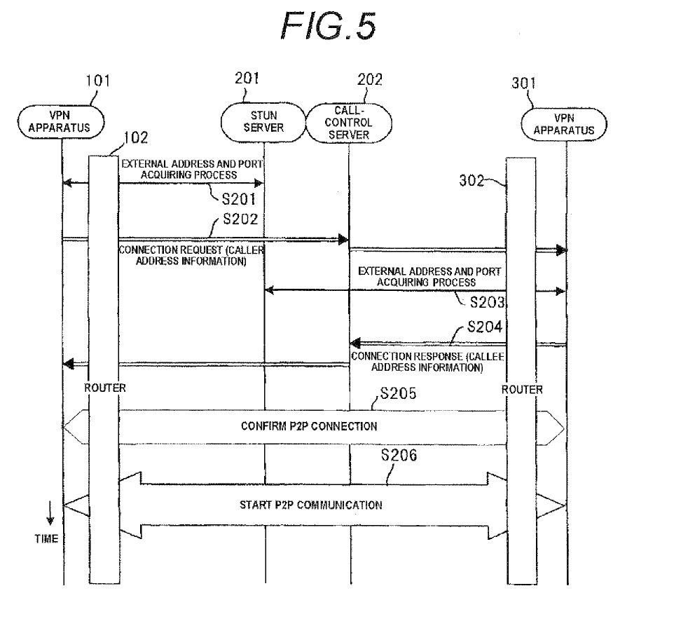

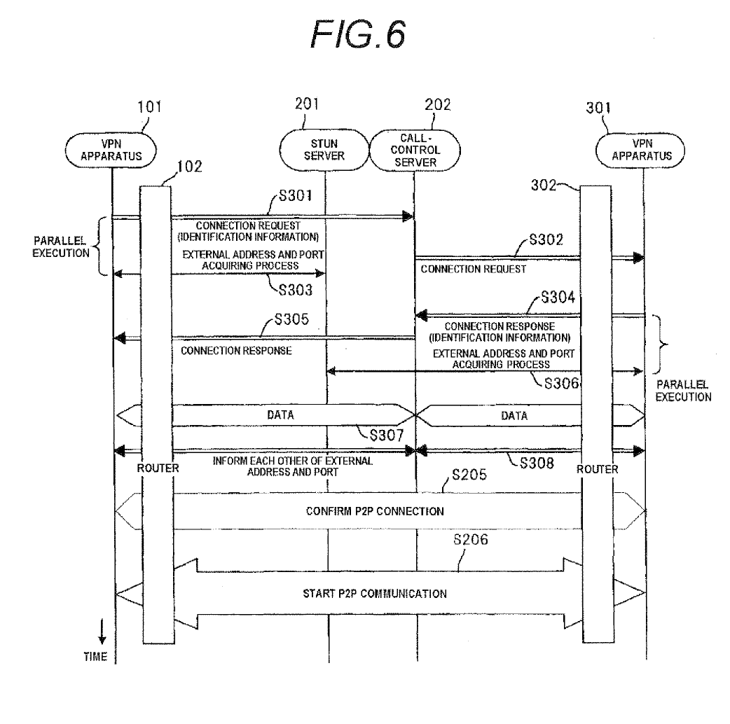

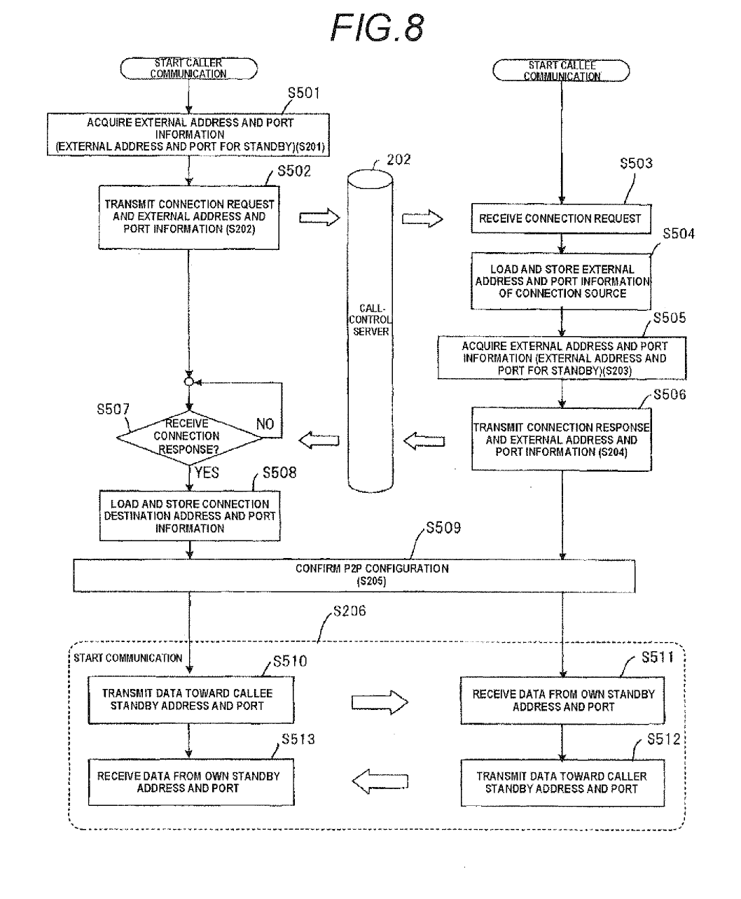

First, the VPN apparatus 101 detects presence or absence of the communication packet from the terminal 103 under the VPN apparatus 101 by the TCP determiner 144 (step S101). The detection process is repeated until the communication packet is detected. When the communication packet is detected, the VPN apparatus 101 determines whether the detected communication packet is the TCP packet or the UDP packet by the TCP determiner 144 (step S102). In a case of the TCP packet, the VPN apparatus 101 decides to perform TCP flow, in other words, decides to perform a process shown in FIGS. 5 and 8 by the sequence decider 145. In a case of the UDP packet, the VPN apparatus 101 decides to perform UDP flow, in other words, decides to perform a process shown in FIGS. 6, 7, 9 and 10 by the sequence decider 145.

As described above, the following communication establishing process sequence (the TCP flow or the flow for the UDP) can be decided based on the type of the communication packet from the terminal 103 under the VPN apparatus 101. Thus, the communication may be performed using a merit of the TCP packet and the UDP packet that have different real time performance and reliability.

Next, the TCP flow will be described with reference to a sequence diagram (FIG. 5).

FIG. 5 is the sequence diagram illustrating a process sequence when establishing the VPN in a case of detecting a TCP packet in the VPN system according to the embodiment. FIG. 5 illustrates a process in the network including the VPN apparatuses, for connecting the terminal 103 under the VPN apparatus 101 to the terminal 303 under the other VPN apparatus 301 through the WAN 200.

Before the process shown in FIG. 5, the VPN apparatus 101 logs in the call-control server 202 to be user-certificated. In a case where the VPN apparatus 101 succeeds at the user certification, a registration and setting of the identification information (a MAC address, a user ID, a telephone number or the like) of the VPN apparatus 101, the position information (the global IP address) on the network or the like are performed in the call-control server 202. After that, the communication can be performed between the VPN apparatus 101 and the call-control server 202. Also, similar to the caller VPN apparatus 101, the callee VPN apparatus 301 logs in the call-control server 202 to be user-certificated, and then the registration and setting of the identification information of the VPN apparatus 301 are performed in the call-control server 202.

In this state, when the VPN apparatus 101 receives a connection request of the VPN connection from the subordinate terminal 103 by the function of the external address and port acquirer 141 according to an activation of the application that performs the VPN communication, the external address and port acquiring process is performed between the VPN apparatus 101 and the STUN server 201 (step S201). At this time, the VPN apparatus 101 sends a binding request (see RFC3489; the same herein below) packet as the external address and port acquiring request with respect to the STUN server 201 so as to acquire the external address and port information (the global IP address and the port number seen from the WAN 200 side) that are assigned to the own apparatus. Meanwhile, the STUN server 201 responses to the external address and port acquiring request and as the external address and port information response, returns to the VPN apparatus 101 the binding response (see RFC3489; the same herein below) packet that includes the external address and port information. Thus, the VPN apparatus 101 stores the external address and port information that are obtained by the external address and port information response.

Next, the VPN apparatus 101 performs the connection request so as to establish the communication path toward the VPN apparatus 301 having thereunder the terminal 303 of the connection destination with respect to the call-control server 202 (step S202). At this me, the VPN apparatus 101 transmits the connection request toward the call-control server 202, wherein the connection request includes the external address and port information (the global IP address and the port number) of the own apparatus that are acquired at the external address and port acquiring process (step S201) as the address information of the caller. The identification information of the callee (the VPN apparatus 301) is also included in the connection request. The call-control server 202 relays the connection request and transmits it toward the VPN apparatus 301 that becomes the connection destination of the VPN connection. According to the connection request, the call-control server 202 informs the connection destination of the request that the VPN apparatus 101 connects the VPN connection toward the VPN apparatus 301 for the P2P path establishment.

When the connection request is received from the call-control server 202, the VPN apparatus 301 of the connection destination performs the external address and port acquiring process between the VPN apparatus 301 and the STUN server 201 (step S203). At this time, the VPN apparatus 301, similarly to the VPN apparatus 101, sends the binding request packet as the external address and port acquiring request with respect to the STUN server 201 so as to acquire the external address and port information (the global IP address and the port number seen from the WAN 200 side) that are assigned to the VPN apparatus 301.

Meanwhile, the STUN server 201 responses to the external address and port acquiring request and as the external address and port information response, returns to the VPN apparatus 301 the binding response packet that includes the external address and port information. Thus, the VPN apparatus 301 stores the external address and port information that is obtained by the external address and port information response.

Next, the VPN apparatus 301 performs the connection response to the connection request to the call-control server 202 (step S204). At this time, the VPN apparatus 301 transmits the connection response toward the call-control server 202, in which the connection response includes the external address and port information (the global IP address and the port number) of the VPN apparatus 301 that are acquired at the external address and port acquiring process (step S203) as the address information of the callee. The identification information of the caller (the VPN apparatus 101) is also included in the connection response. The call-control server 202 relays the connection response and transmits it toward the VPN apparatus 101 that is a connection requestor of the VPN connection. According to the connection response, the call-control server 202 informs the connection requestor of the response from the VPN apparatus 301 toward the VPN apparatus 101 with respect to the connection request.

In this step, the VPN apparatus 101 of the connection source and the VPN apparatus 301 of the connection destination acquire each other's external address and port information. Thus, the VPN apparatus 101 and the VPN apparatus 301 transmit the packet through the WAN 200 by setting each other's external address and port information (the global IP address and the port number) as the transmission destination, and the VPN function section 142 confirms whether the P2P communication is possible (VPN connection is possible through P2P) or not (step S205). For example, in a case where the response is received showing that the VPN apparatus 101 transmits the packet toward the VPN apparatus 301 and the packet is received from the VPN apparatus 301 within the predetermined period from the transmission, the P2P communication is determined possible. When the P2P communication is possible, the VPN apparatus 101 and the VPN apparatus 301 starts the encrypted data communication (the VPN communication) through P2P communication path (step S206). In other words, after determining whether the P2P communication is possible or not, the transmission of actual data (the communication data such as voice packet or video packet) starts.

As described above, in the embodiment, in a case where the data is determined as the TCP packet, the data communication starts after the VPN communication (the P2P communication) is established, and the transmission time of the data is delayed until the VPN communication starts.

Also, in a case where the TCP packet is transmitted, in the embodiment, only the VPN communication path is used.

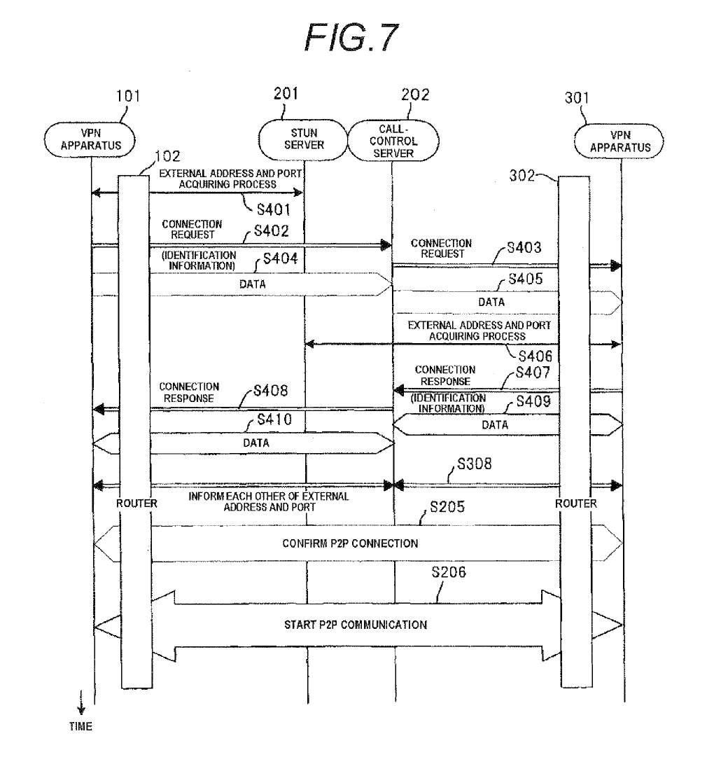

Next, the UDP flow will be described with reference to the sequence diagrams (FIGS. 6 and 7).

FIG. 6 is a sequence diagram illustrating a process sequence when establishing the VPN in a case of detecting the UDP packet in the VPN system according to the embodiment. FIG. 6 illustrates a process in the network including the VPN apparatuses, for connecting the terminal 103 under the VPN apparatus 101 to the terminal 303 under the other VPN apparatus 301 through the WAN 200.

First, similarly to the process shown in FIG. 5, the VPN apparatuses 101 and 301 log in the call-control server 202 to be user-certificated, and the registration and setting of the identification information of the VPN apparatus 101 and the VPN apparatus 301 are performed in the call-control server 202.

In this state, when the VPN apparatus 101 receives a connection request of the VPN connection from the subordinate terminal 103 by the function of the external address and port acquirer 141 according to an activation of the application that performs the VPN communication, the connection request is performed to establish the communication path toward the VPN apparatus 301 having thereunder the terminal 303 the connection destination with respect to the call-control server 202 (step S301). At this time, the VPN apparatus 101 transmits the connection request that includes the identification information of the caller and the caller toward the call-control server 202. The call-control server 202 relays the connection request and transmits it toward the VPN apparatus 301 being as the connection destination of the VPN connection (step S302). According to the connection request, the call-control server 202 informs the connection destination of the request that the VPN apparatus 101 connects the VPN connection toward the VPN apparatus 301.

Simultaneously and in parallel with the connection request by the VPN apparatus 101, the VPN apparatus 101 performs the external address and port acquiring process between the VPN apparatus 101 and the STUN server 201 (step S303). At this time, the VPN apparatus 101 sends a binding request packet as the external address and port acquiring request with respect to the STUN server 201 so as to acquire the external address and port information (the global IP address and the port number seen from the WAN 200 side) that are assigned to the VPN apparatus 101. Meanwhile, the STUN server 201 responses to the external address and port acquiring request and as the external address and port information response, returns to the VPN apparatus 101 the binding response packet that includes the external address and port information. Thus, the VPN apparatus 101 stores the external address and port information that are obtained by the external address and port information response.

When the VPN apparatus 301 of the connection destination receives a connection request from the call-control server 202, the VPN apparatus 301 performs the connection response to the connection request with respect to the call-control server 202 (step S304). At this time, the VPN apparatus 301 transmits the connection response that includes the identification information of the caller and the callee toward the call-control server 202. The call-control server 202 relays the connection response and transmits it toward the VPN apparatus 101 being as the connection requestor of the VPN connection (step S305). According to the connection response, the call-control server 202 informs the connection requestor of the response from the VPN apparatus 301 to the VPN apparatus 101 with respect to the connection request.

Simultaneously and in parallel with the connection response by the VPN apparatus 301, the VPN apparatus 301 performs the external address and port acquiring process between the VPN apparatus 301 and the STUN server 201 (step S306). At this time, the VPN apparatus 301, similarly to the VPN apparatus 101, sends a binding request packet as the external address and port acquiring request with respect to the STUN server 201 so as to acquire the external address and port information (the global IP address and the port number seen from the WAN 200 side) that are assigned to the VPN apparatus 301. Meanwhile, the STUN server 201 responses to the external address and port acquiring request and as the external address and port information response, returns to the VPN apparatus 301 the binding response packet that includes the external address and port information. Thus, the VPN apparatus 301 stores the external address and port information that is obtained by the external address and port information response.

When the VPN apparatus 101 receives the connection response including the connection admission from the VPN apparatus 301, the VPN apparatus 101 and the VPN apparatus 301 performs the communication of actual data (the communication data such as the control data) to each other through the call-control server 202 (step S307). In other words, before establishing the real communication path, the communication of the actual data starts.

Next, the VPN apparatus 101 and the VPN apparatus 301 inform each external address and port information of the own apparatus that are acquired from the STUN server 201 to each other through the call-control server 202 (step S308).

Then, the above-described steps S205 and S206 processes are performed. In other words, the VPN apparatus 101 and the VPN apparatus 301 determine whether the P2P communication is possible or not between the VPN apparatus 101 and the VPN apparatus 301 using the external address and port information of the partners that are received to each other (step S205). Here, the external address and port information (the global IP address and the port number) of the partners are set as the transmission destination to each other, the packet is transmitted through the WAN 200 and then it is confirmed whether the communication is possible or not. In a case where the P2P communication is possible, since the P2P communication path is established, the VPN apparatus 101 and the VPN apparatus 301 start the communication of the actual data that is encrypted to each other by the P2P communication (step S206).

As described above, in the embodiment, in a case where the packet is determined as the UDP packet, the data transmission starts through the network before establishing the VPN communication (the P2P communication). In other words, the data transmission starts through the call-control server 202 that is present on the network.

Then, the transmission of the data is performed by the VPN communication after the VPN communication is established.

FIG. 7 is a sequence diagram illustrating another process sequence when establishing the VPN in a case of detecting the UDP packet in the VPN system according to the embodiment. FIG. 7 illustrates a process in the network including the VPN apparatuses, for connecting the terminal 103 under the VPN apparatus 101 to the terminal 303 under the other VPN apparatus 301 through the WAN 200.

First, similarly to the process sequence shown in FIG. 5, the VPN apparatuses 101 and 301 login to the call-control server 202 to be user-certificated, and the registration and setting of the identification information of the VPN apparatus 101 and the VPN apparatus 301 are performed in the call-control server 202.

In this state, when the VPN apparatus 101 receives a connection request of the VPN connection from the subordinate terminal 103 by the function of the external address and port acquirer 141 according to the activation of the application that performs the VPN communication, the VPN apparatus 101 performs the external address and port acquiring process between the VPN apparatus 101 and the STUN server 201 (step S401). At this time, the VPN apparatus 101 transports a binding request packet as the external address and port acquiring request with respect to the STUN server 201 so as to acquire the external address and port information that are assigned to the VPN apparatus 101. Meanwhile, the STUN server 201 responses to the external address and port acquiring request and as the external address and port information response, returns to the VPN apparatus 101 the binding response packet that includes the external address and port information. Thus, the VPN apparatus 101 stores the external address and port information that are obtained by the external address and port information response.

Next, the connection request is performed to establish the communication path of P2P toward the VPN apparatus 301 having thereunder the terminal 303 of the connection destination with respect to the call-control server 202 (step S402). At this time, the VPN apparatus 101 transmits the connection request that includes the identification information of the caller and the callee toward the call-control server 202. The call-control server 202 relays the connection request and transmits it toward the VPN apparatus 301 being as the connection destination of the VPN connection (step S403). According to the connection request, the call-control server 202 informs the connection destination of the request that the VPN apparatus 101 connects the VPN connection for establishing the P2P path toward the VPN apparatus 301.

Also, when the VPN apparatus 101 transmits the connection request toward the VPN apparatus 301, the actual data (the communication data such as the control data) is transmitted through the call-control server 202. Thus the VPN apparatus 301 receives the actual data (step S404 and step S405).

When the VPN apparatus 301 of the connection destination receives the connection request from the call-control server 202, the VPN apparatus 301 performs the external address and port acquiring process between the VPN apparatus 301 and the STUN server 201 (step S406). At this time, the VPN apparatus 301, similarly to the above-described VPN apparatus 101, transports a binding request packet as the external address and port acquiring request with respect to the STUN server 201 so as to acquire the external address and port information that are assigned to the VPN apparatus 301. Meanwhile, the STUN server 201 responses to the external address and port acquiring request and as the external address and port information, returns to the VPN apparatus 301 the binding response packet that includes the external address and port information. Thus, the VPN apparatus 301 stores the external address and port information that are obtained by the external address and port information response.

Next, the VPN apparatus 301 performs the connection response corresponding to the connection request with respect to the call-control server 202 (step S407). At this time, the VPN apparatus 301 transmits the connection response toward the call-control server 202, in which the connection response includes the identification information of the caller and callee. The call-control server 202 relays the connection response and transmits it toward the VPN apparatus 101 being as the connection requestor of the VPN connection (step S408). According to the connection response, the call-control server 202 informs the connection requestor of the response from the VPN apparatus 301 toward the VPN apparatus 101 with respect to the connection request.

Also, when the VPN apparatus 301 transmits the connection response that includes the connection admission toward the VPN apparatus 101, the VPN apparatus 301 performs the communication of the actual data (both the transmission and the receiving are possible) through the call-control server 202 between the VPN apparatus 301 and the VPN apparatus 101 (steps S409 and S410). After the VPN apparatus 101 and the VPN apparatus 301 start the data communication to each other, the VPN apparatus 101 and the VPN apparatus 301 inform the external address and port information of the own apparatus that are acquired from the STUN server 201 through the call-control server 202 to each other (step 308). Thus, the P2P connection confirmation process (step S205) is performed and the P2P communication starts if the P2P communication is possible, similarly to the processes shown in FIGS. 5 and 6 (step 206).

As described above, in the embodiment, in a case where the packet is determined as the UDP packet, the data transmission starts through the network before establishing the VPN communication (the P2P communication). In other words, the data transmission starts through the call-control server 202 that is present on the network.

Then, the transmission of the data is performed by the VPN communication after the VPN communication is established.

Next, a flowchart (FIG. 8) regarding a TCP flow will be described.

FIG. 8 is a flowchart illustrating an example of process details when establishing the VPN connection in a case of detecting the TCP packet in the VPN apparatus according to the embodiment. FIG. 8 illustrates the detailed process details regarding the process when establishing the VPN connection in a case where the TCP packet in FIG. 5 is detected.

Similarly to the process sequence in FIG. 5, the VPN apparatuses 101 and 301 login to the call-control server 202 to be user-certificated, and then the registration and setting of the identification information of the VPN apparatus 101 and the VPN apparatus 301 in the call-control server 202 are performed.

First, to perform the VPN connection when establishing the VPN connection, the VPN apparatus 101 of the caller performs a process to acquire the external address and port information that includes the global IP address and the port number of the VPN apparatus 101 as the external address and port information for standby (step S501 and step S201).

Next, the VPN apparatus 101 transmits the connection request with respect to the VPN apparatus 301 of the callee (step S502 and step S202). The connection request includes the identification information or the like to specify the terminal 303 under the connection destination. The connection request is transmitted by including the external address and port information of the VPN apparatus 101 that are acquired in step S501. The connection request is transmitted to the VPN apparatus 301 through the call-control server 202.

The VPN apparatus 301 of the callee receives the connection request from the VPN apparatus 101 (step S503). When the connection request is received, the VPN apparatus 301 loads the external address and port information of the connection source (the VPN apparatus 101 side) that is contained in the connection request, and stores the information in the memory (step S504). Thus, the VPN apparatus 301 performs a process to acquire the external address and port information that include the global IP address and the port number of the VPN apparatus 301 (the partner apparatus, when seen from the VPN apparatus 101) as the external address and port information for standby, similarly to step S501 (steps S505 and S203).

The VPN apparatus 301 transmits the connection response with respect to the connection request that is received from the VPN apparatus 101 of caller (step S506). In the connection response, the external address and port information of the VPN apparatus 301 that are acquired in step S505 are included and transmitted. The connection response is transmitted to the VPN apparatus 101 through the call-control server 202.

The VPN apparatus 101 of the caller determines whether the connection response is received or not and performs the standby of the connection response (step S507). When the connection response is received, the VPN apparatus 101 loads the external address and port information of the connection destination (the VPN apparatus 301 side) that are included in the connection response and stores the information in the memory (step S508). Thus, the VPN apparatus 101 and the VPN apparatus 301 confirm whether the P2P communication is possible or not to each other (step S509).

According to the above-described process, the VPN apparatus 101 of the caller acquires the external address and port information of the VPN apparatus 101 and the external address and port information of the VPN apparatus 301 of the callee at the time of performing the P2P communication start process (step S206) in a case where the P2P communication is the possible. Meanwhile, the VPN apparatus 301 of callee acquires the external address and port information of the VPN apparatus 301 and the external address and port information of the VPN apparatus 101 of the caller.

After the P2P communication starts, the VPN apparatus 101 of caller takes the global IP address and the port number which the VPN apparatus 301 of callee is on standby as the destination and transmits the actual data toward the VPN apparatus 301 by the P2P communication (step S510). Meanwhile, the VPN apparatus 301 performs the standby of the data by the global IP address and the port number for the standby of the VPN apparatus 301 and receives the actual data that is transmitted from the VPN apparatus 101 of caller (step S511). Also, the VPN apparatus 301 of callee takes the global IP address and the port number which the VPN apparatus 101 of caller is on standby as the destination and transmits the actual data toward the VPN apparatus 101 by the P2P communication (step S512). Meanwhile, the VPN apparatus 101 performs the standby of the data by the global IP address and the port number for the standby of the VPN apparatus 101 and receives the actual data that is transmitted from the VPN apparatus 301 of callee (step S513).

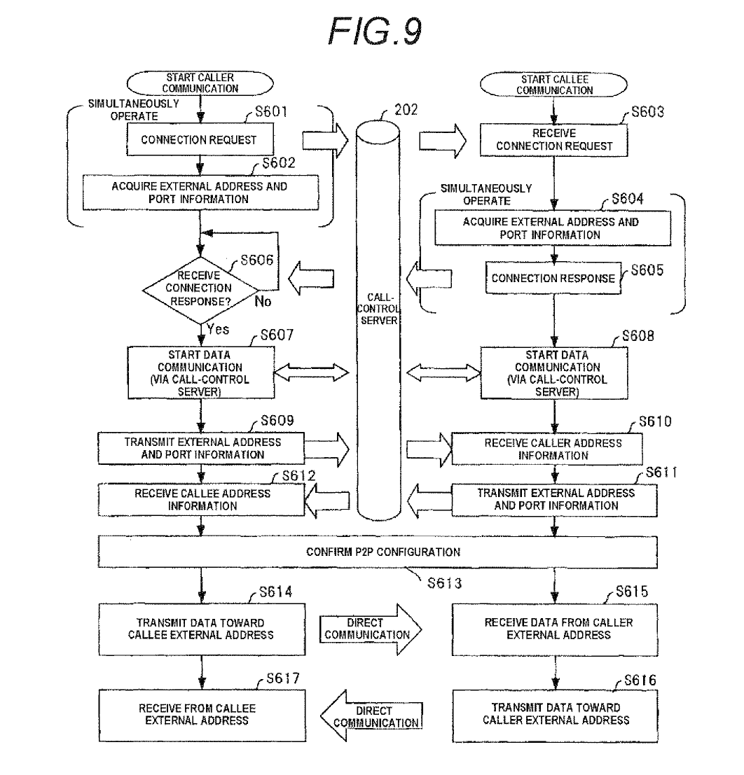

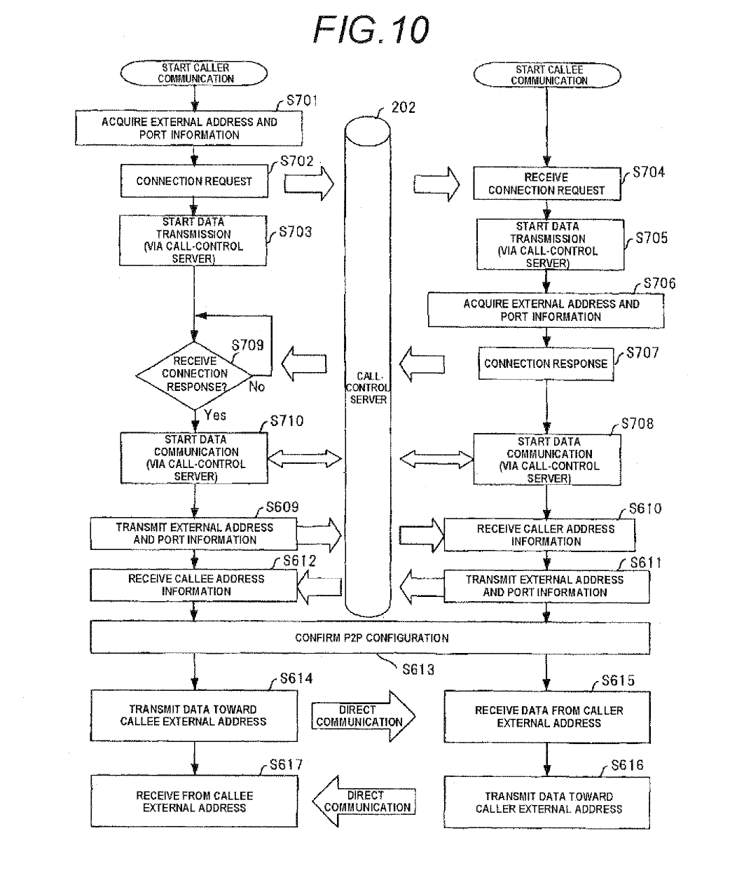

Next, the flowchart (FIGS. 9 and 10) regarding the UDP flow will be described.

FIG. 9 is a flowchart illustrating a process sequence when establishing the VPN in a case of detecting the UDP packet corresponding to the sequence diagram of FIG. 6. FIG. 9 illustrates a process in the network including the VPN apparatuses, for connecting the terminal 103 under the VPN apparatus 101 to the terminal 303 under the other VPN apparatus 301 through the WAN 200.

First, similarly to the process sequence shown in FIG. 5, the VPN apparatuses 101 and 301 login to the call-control server 202 to be user-certificated; and the registration and setting of the identification information of the VPN apparatus 101 and the VPN apparatus 301 are performed in the call-control server 202.

The VPN apparatus 101 transmits the connection request toward the VPN apparatus 301 through the call-control server 202 (step S601) and acquires the external address and port information of the VPN apparatus 101 from the STUN server 201 (step S602). When the VPN apparatus 301 receives the connection request from the VPN apparatus 101 (step S603), acquires the external address and port information of the VPN apparatus 301 from the call-control server 202 (step S604) and transmits the connection response toward the VPN apparatus 101 through the call-control server 202 (step S605).

The VPN apparatus 101 determines whether the connection response is received or not from the VPN apparatus 301 (step S606) and standbys until receiving the connection response in a case where the response is not received. When the VPN apparatus 101 receives the connection response that includes the connection admission, the VPN apparatus 101 and the VPN apparatus 301 start the actual data communication through the call-control server 202 (step S607 and step S608).

After the data communication starts, the VPN apparatus 101 transmits the external address and port information of the VPN apparatus 101 that are acquired from the STUN server 201 through the call-control server 202 toward the VPN apparatus 301 (step S609). Thus, the VPN apparatus 301 receives the external address and port information of the VPN apparatus 101 as the address information of the caller toward the VPN apparatus 101 (step S610). Similarly, the VPN apparatus 301 transmits the external address and port information of the VPN apparatus 301 that are acquired from the STUN server 201 through the call-control server 202 (step S611). Thus, the VPN apparatus 101 receives the external address and port information of the VPN apparatus 301 as the address information of the callee (step S612).

Next, the VPN apparatus 101 and the VPN apparatus 301 use the external address and port information that are received from the partner to each other and confirms whether P2P connection is possible or not (step S613). As described above, it is confirmed whether P2P communication is possible or not.

In a case where the P2P communication is possible, the VPN apparatus 101 and the VPN apparatus 301 start the P2P communication. Specifically, the VPN apparatus 101 performs the actual data transmission toward the VPN apparatus 301 with the P2P communication based on the external address and port information of the VPN apparatus 301 (step S614). Thus, the VPN apparatus 301 receives the actual data from the VPN apparatus 101 (step S615). Similarly, the VPN apparatus 301 performs the actual data transmission toward the VPN apparatus 101 with the P2P communication based on the external address and port information of the VPN apparatus 101 (step S616). Thus, the VPN apparatus 101 receives the actual data from the VPN apparatus 301 (step S617).

Next, FIG. 10 is a flowchart illustrating another process sequence when establishing the VPN in a case of detecting the UDP packet corresponding to the sequence diagram of FIG. 7. FIG. 10 illustrates a process in the network including the VPN apparatuses, for connecting the terminal 103 under the VPN apparatus 101 to the terminal 303 under the other VPN apparatus 301 through the WAN 200.

First, similarly to the process sequence shown in FIG. 5, the VPN apparatuses 101 and 301 login to the call-control server 202 to be user-certificated, and the registration and setting of the identification information of the VPN apparatus 101 and the VPN apparatus 301 are performed in the call-control server 202.

The VPN apparatus 101 acquires the external address and port information of the VPN apparatus 101 from the call-control server 202 (step S701). Next, the VPN apparatus 101 transmits the connection request toward the VPN apparatus 301 through the call-control server 202 (step S702). Also, the VPN apparatus 101 transmits the connection request and starts the transmission of the actual data toward the VPN apparatus 301 through the call-control server 202 (step S703).

When the VPN apparatus 301 receives the connection request from the VPN apparatus 101 (step S704), the VPN apparatus 301 starts the receiving of actual data from the VPN apparatus 101 through the call-control server 202 (step S705). Next, the VPN apparatus 301 acquires the external address and port information of the VPN apparatus 301 from the STUN server 201 (step S706).

Next, the VPN apparatus 301 transmits the connection response toward the VPN apparatus 101 through the call-control server 202 (step S707). When the VPN apparatus 301 transmits the connection response that includes the connection admission, the VPN apparatus 301 starts the communication of the actual data between the VPN apparatus 301 and the VPN apparatus 101 through the call-control server 202 (step S708).

The VPN apparatus 101 determines whether the connection response is received or not from the VPN apparatus 301 (step S709) and waits until receiving the connection response in a case where connection response is not received. When the VPN apparatus 101 receives the connection response that includes the connection admission, the VPN apparatus 101 starts the communication of the actual data between the VPN apparatus 101 and the VPN apparatus 301 through the call-control server 202 (step S710).

The process after the VPN apparatus 101 and the VPN apparatus 301 start the data communication to each other is the same as the process of steps S609 to S617 in FIG. 9.

In the TCP flow, in other words, according to the process sequence in FIGS. 5 and 8, regarding the TCP packet, the transmitting/receiving of the UDP packet that needs the real time performance can be practiced in a burst manner on a priority basis without performing the transmitting/receiving of the TCP packet through the call-control server 202 before confirming whether the P2P communication is possible or not, in other words, before establishing the path of the P2P communication. Even in a case where the TCP packet to be transmitted is present before determining whether the P2P communication is possible or not, the TCP packet is destroyed before determining whether the P2P communication is possible or not. Even in a case where the TCP packet is destroyed, the retransmission request of the destroyed TCP packet is generated periodically by the retransmission control function of the TCP protocol. Thus, according to the retransmission request after determining whether the P2P communication is possible or not, the packet that is the same as the contents of the destroyed TCP packet before determination can be transmitted automatically to the VPN apparatus 301. Accordingly; the TCP packet may not be omitted and then the TCP communication between a plurality of the VPN apparatuses 101 and 301 is secured after establishing the communication path.

Also, such the flow for the UDP, in other words, according to the process sequence in FIG. 6, FIG. 7, FIG. 9 and FIG. 10, before confirming whether the P2P communication is possible or not, in other words, before the P2P communication path is established, the communication of the UDP packet is performed through the call-control server 202. Thus, even in a case where the communication packet occurs in a burst manner, regarding the UDP packet in which the real time performance is requested, the transmission starts before determining whether the P2P communication is possible or not prior to the transmission of the TCP packet so that the load generated in the call-control server can be decreased and the delay of the data communication or the failure of communication can be prevented from being generated regarding the data that highly needs the real time performance. Also, regarding the UDP packet, the delay of the data communication start that is caused by the time necessary to confirm whether the P2P communication is possible or not, can be avoided and the high-speed data communication can be performed. Specifically, in FIG. 7 and FIG. 10, since the UDP packet can be transmitted with the connection request, the further high-speed data communication can be performed. As described above, the load generated in the server that relays the communication packet until establishing the communication path between the plurality of the VPN apparatuses 101 and 301 can be decreased, and the generation of the communication delay and the communication failure can be constrained to a minimum.

### Modified Example

In the above-described embodiment, the VPN apparatus having the VPN function is arranged as an independent apparatus, and the subordinate terminal is arranged under the VPN apparatus, however only the VPN apparatus (here, the terminal that has the VPN function) may be arranged. Hereinafter, description will be given regarding only the difference from the VPN system illustrated in FIG. 1 and VPN apparatus illustrated in FIG. 3.

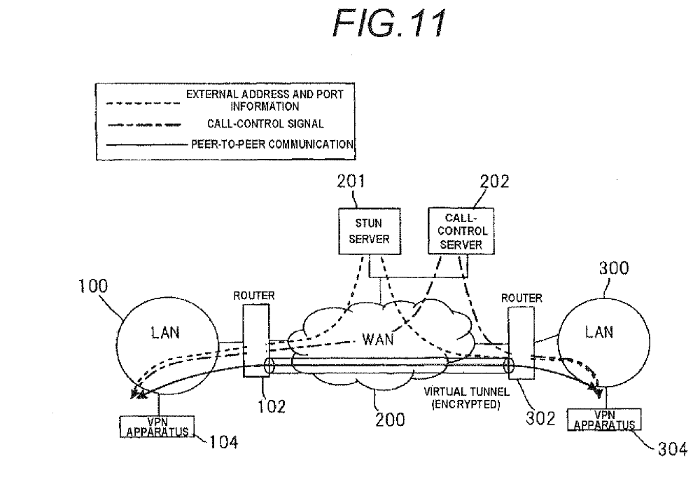

FIG. 11 illustrates a modified configuration example of the VPN system according to the embodiment of the invention. Difference from the VPN system configuration that is illustrated in FIG. 1 is that the system includes a VPN apparatus 104 instead of the VPN apparatus 101 and the subordinate terminal 103 and similarly includes a VPN apparatus 304 instead of the VPN apparatus 301 and the subordinate terminal 303.

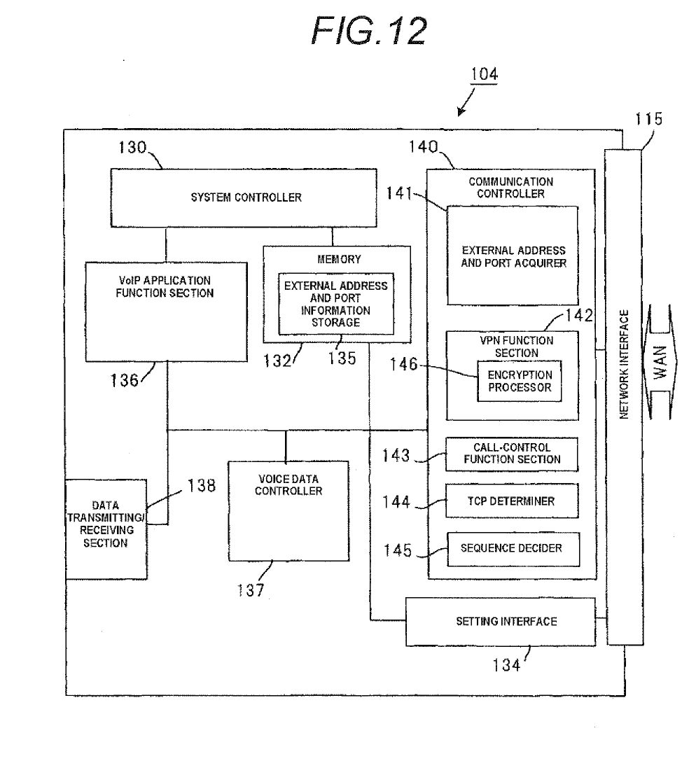

FIG. 12 is a block diagram illustrating a functional configuration example (the modified configuration example) of the VPN apparatus 104 according to the embodiment of the invention. Here, difference from the VPN apparatus 101 that is illustrated in FIG. 3 will be described.

The VPN apparatus 104 does not include the network interface 114 that is connected to the subordinate terminal, the subordinate terminal manager 131 and the data relay section 133, instead includes a VoIP (Voice Over Internet Protocol) application function section 136, a voice data controller 137 and a data input/output section 138 as the functional configuration. Each of these functions is realized according to the operation of the hardware or the CPU 111 which performs the predetermined program.

The VoIP application function section 136 executes various programs that realize the VoIP application function. The voice data controller 137 performs control of the voice data that is transmitted/received between another terminal or is input/output to the data input/output section 138. The data input/output section 138 has functions that have the microphone, the speaker, the operation panel or the like and performs the input/output function of various the data such as the voice data or the like. Also, the communication controller 140 has a function that transmits/receives the communication data instead of the data relay section 133.

Here, it is assumed that the VPN apparatus 104 has a voice telephone function by VoIP. However, it may be the terminal that is used in the other VPN communication as described above.

Also, regarding the process sequence when establishing the VPN, it is basically similar to the process sequence illustrated in FIGS. 4 to 10. However the VPN apparatus 104 performs the self-connection request by the application activation according to the VoIP application function section 136. Also, the VPN apparatus 104 determines the type of the actual data to be transmitted by the communication controller 140 according to the TCP determiner 144. Thus, based on the determination result, the priority order that performs the predetermined process, in other words, the sequence of the determination whether the P2P communication is possible or not and the transmission start of the actual data is determined by the process-sequence determiner 145.

According to the VPN apparatuses 104 and 304 of the embodiment, the communication delay can be prevented from being generated when the communication is performed between a plurality of the VPN apparatuses (here, the terminals that have the VPN function) and the data communication can be high speed without providing the VPN apparatuses independently. Specifically, in a case where the communication packet is the UDP packet, the real time performance is seriously considered and then the communication can start via the call-control server 202 before confirming the communication path establishment. Also, in a case where the communication packet is the TCP packet, since there are many packets in which the real time performance is not seriously considered, the transmitting of the packet waits before confirming the communication path establishment and the communication can start after confirming the communication path establishment. Thus, even in a case where the communication packet is transmitted in burst manner when the VPN communication starts is generated, the priority of the transmitting of the communication packet can be determined according to the characteristics of the communication packet, and the transmitting process is performed according to the decision so that the call-control server and the load on the line can be decreased. Also, during the standby of the transmitting of the TCP packet, the TCP packet is practically destroyed. However the same packet can be retransmitted after the predetermined period by the retransmission control function of the TCP protocol.

Also, in the embodiment, description was given in detail in which the P2P communication is performed. However, the VPN communication may be assumed other than the P2P communication.

The data communication that is performed via the call-control server if necessary may be performed after the VPN communication establishment.

According to the embodiment, there is provided a networking method of a communication apparatus in which global address information and port information are acquired on a network, and a virtual private network is established with another communication apparatus using the global address information and the port information to perform the communication, the networking method including: determining whether communication data that is to be transmitted from the communication apparatus is a first protocol or a second protocol; and starting a data transmission through the network before the virtual private network is established when the communication apparatus determines that the communication data is the first protocol, and starting a data transmission after the virtual private network is established when the communication apparatus determines that the communication data is the second protocol.

Accordingly, the generation of the communication delays and the communication failure can be constrained to a minimum until establishing the VPN communication path between the plurality of the VPN apparatus.

Furthermore, the communication data is transmitted through the virtual private network after the virtual private network is established.

Furthermore, the virtual private network is the P2P communication between the communication apparatus and the other communication apparatus.

Furthermore, there is provided a program for performing each step of the networking method of the communication apparatus and the generation of the communication delays and the communication failure when the VPN communication is started between a plurality of the VPN apparatuses can be constrained to a minimum according to the program.

Furthermore, there is provided a non-transitory computer readable storage medium in which is stored a program performing each step of the networking method of the communication apparatus and the generation of the communication delays and the communication failure can be constrained to a minimum according to the storage medium when the VPN communication starts between the plurality of the VPN apparatus.

According to the embodiment, there is provided a networking method of a communication apparatus in which global address information and port information are acquired on a network, and a virtual private network is established with another communication apparatus using the global address information and the port information to perform the communication, the networking method including: determining whether communication data that is to be transmitted from the communication apparatus is a first protocol or a second protocol; and transmitting data through the network before a virtual private network is established and transmitting data through the virtual private network after the virtual private network is established when the communication apparatus determines that the communication data is the first protocol, and transmitting data only through the virtual private network when the communication apparatus determines that the communication data is the second protocol.

Accordingly, the generation of the communication delays and the communication failure can be constrained to a minimum until the VPN communication path is established between the plurality of the VPN apparatus.

According to the embodiment, there is provided a communication apparatus in which global address information and port information are acquired on a network, and a virtual private network is established with another communication apparatus using the global address information and the port information to perform the communication, the communication apparatus including: a communication data transmitter that transmits communication data to the other communication apparatus; and a data type determiner that determines whether the communication data that is to be transmitted from the communication data transmitter is a first protocol or a second protocol, wherein the communication data transmitter starts a data transmission through the network before the virtual private network is established when the data type determiner determines that the communication data is the first protocol, and starts a data transmission after the virtual private network is established when the data type determiner determines that the communication data is the second protocol.

Accordingly, the generation of the communication delays and the communication failure can be constrained to a minimum until the VPN communication path is established between the plurality of the VPN apparatus.

Furthermore, the first protocol is a UDP and the second protocol is a TCP.

Furthermore, the communication apparatus includes a communication data receiver that receives the communication data from the communication terminal under control of the communication apparatus and a communication data transmitter that transmits the communication data that is received by the communication data receiver so that when the transmission request from the terminal under the VPN apparatus is occurred, based on the type of the communication data from the terminal that is to be transmitted, the transmission timing of the communication data can be determined, the load on the system with respect to the communication generation in burst manner when the communication starts, can be decreased and then the generation of the communication delays and the communication failure of the communication data can be constrained to minimum.

Furthermore, the virtual private network is the P2P communication between the communication apparatus and the other communication apparatus.

According to the embodiment, there is provided a communication apparatus in which a virtual private network is established with another communication apparatus on a network to perform the communication, the communication apparatus including: an external address and port information acquirer that acquires global address information and port information of the communication apparatus that are used when the communication apparatus communicates through the network; an external address and port information transmitter that transmits the global address information and the port information of the communication apparatus toward the other communication apparatus through the network; an external address and port information receiver that receives global address information and port information of the other communication apparatus from the other communication apparatus through the network; a communication state determiner that determines whether a VPN communication is possible or not between the communication apparatus and the other communication apparatus, using the global address information and the port information of the other communication apparatus; a communication data transmitter that transmits the communication data to the other communication apparatus, a data type determiner that determines a protocol type of the communication data that is transmitted by the communication data transmitter; and a sequence decider that decides a sequence of the determination of whether the VPN communication is possible or not by the communication state determiner and the transmission start of the communication data by the communication data transmitter based on a determination result by the data type determiner.

According to the configuration, the generation of the communication delays and the communication failure can be constrained to a minimum until the VPN communication path is established between the plurality of the VPN apparatus.

Furthermore, in a case where the communication data is determined as the UDP data by the data type determiner, the sequence decider decides to start the transmission of the communication data before the communication state determiner determines whether the VPN communication is possible or not, and the data transmitter starts the transmission of the communication data toward the other communication apparatus through the network before the communication state determiner determines whether the VPN communication is possible or not so that even when the communication data is generated in burst manner, the UDP data in which the real time performance is needed can be rapidly transmitted, and the generation of the communication delays can be constrained to a minimum when the VPN communication is established.

Furthermore, in a ease where the communication data is determined as the TCP data by the data type determiner, the sequence decider decides to start the transmission of the communication data after the communication state determiner determines whether the VPN communication is possible or not, and the data transmitter starts the transmission of the communication data toward the other VPN apparatus through the communication path determined that the VPN communication is possible, after the communication state determiner determines whether the VPN communication is possible or not so that even when the communication data is generated in burst manner in the communication by the packet of TCP/UDP, the data transmitting waits until the VPN communication path is established regarding the TCP data in which the real time performance is not needed, the UDP data in which the real time performance is needed can be transmitted in a burst manner, and the generation of the communication delays and the communication failure can be constrained to a minimum when the VPN communication starts. Furthermore, even when the TCP data is destroyed during the standby, the TCP data can be prevented from being omitted by the retransmission control function of the TCP protocol.

According to the embodiment, there is provided a networking method of a communication apparatus in which a virtual private network is established with another communication apparatus on a network to perform the communication, the networking method including: acquiring global address information and port information of the communication apparatus that is used when the communication apparatus communicates through the network; transmitting the global address information and the port information of the communication apparatus toward the other communication apparatus through the network; receiving global address information and port information of the other communication apparatus from the other communication apparatus through the network; determining whether a VPN communication is possible or not between the communication apparatus and the other communication apparatus, using the global address information and the port information of the other communication apparatus;

transmitting communication data to the other communication apparatus; determining a protocol type of the communication data that is to be transmitted; and deciding a sequence of the determination of whether the VPN communication is possible or not and the transmission start of the communication data based on a determination result of the protocol type of the communication data.

According to the configuration, the generation of the communication delays and the communication failure can be constrained to a minimum until the VPN communication path is established between the plurality of the VPN apparatus.

The invention is useful in the communication apparatus, the networking method of the communication apparatus, the program, the storage medium or the like in which the decrease of the server load, the generation of the communication delays and the communication failure can be constrained to a minimum when the communication starts between the plurality of the VPN apparatuses.

What is claimed is:

1. A networking method of a communication apparatus in which global address information and port information are acquired on a network, and a virtual private network is established with another communication apparatus using the global address information and the port information to perform the communication, the networking method comprising:
determining whether communication data that is to be transmitted from the communication apparatus is a first protocol or a second protocol; and
starting a data transmission through the network before the virtual private network is established when the communication apparatus determines that the communication data is the first protocol, and starting a data transmission after the virtual private network is established when the communication apparatus determines that the communication data is the second protocol.

2. The networking method according to claim 1, wherein the first protocol is a UDP (User Datagram Protocol) and the second protocol is a TCP (Transmission Control Protocol).

3. The networking method according to claim 1, wherein the communication data is transmitted through the virtual private network after the virtual private network is established.

4. The networking method according to claim 1, wherein the virtual private network is a P2P (Peer-to-Peer) communication between the communication apparatus and the other communication apparatus.

5. A non-transitory computer readable storage medium in which is stored a program performing each step in the networking method of the communication apparatus according to claim 1.

6. A networking method of a communication apparatus in which global address information and port information are acquired on a network, and a virtual private network is established with another communication apparatus using the global address information and the port information to perform the communication, the networking method comprising:
determining whether communication data that is to be transmitted from the communication apparatus is a first protocol or a second protocol; and
transmitting data through the network before a virtual private network is established and transmitting data through the virtual private network after the virtual private network is established when the communication apparatus determines that the communication data is the first protocol, and transmitting data only through the virtual private network when the communication apparatus determines that the communication data is the second protocol.

7. A communication apparatus in which global address information and port information are acquired on a network, and a virtual private network is established with another communication apparatus using the global address information and the port information to perform the communication, the communication apparatus comprising:
a communication data transmitter that transmits communication data to the other communication apparatus; and
a data type determiner that determines whether the communication data that is to be transmitted from the communication data transmitter is a first protocol or a second protocol, wherein
the communication data transmitter starts a data transmission through the network before the virtual private network is established when the data type determiner determines that the communication data is the first protocol, and starts a data transmission after the virtual private network is established when the data type determiner determines that the communication data is the second protocol.

8. The communication apparatus according to claim 7, wherein the first protocol is a UDP (User Datagram Protocol) and the second protocol is a TCP (Transmission Control Protocol).

9. The communication apparatus according to claim 7, further comprising a communication data receiver that receives communication data from a communication terminal being under control of the communication apparatus, wherein
the data transmitter transmits the communication data that is received by the communication data receiver.

10. The communication apparatus according to claim 7, wherein the virtual private network is a P2P (Peer-to-Peer) communication between the communication apparatus and the other communication apparatus.

11. A communication apparatus in which a virtual private network is established with another communication apparatus on a network to perform the communication, the communication apparatus comprising:
an external address and port information acquirer that acquires global address information and port information of the communication apparatus that are used when the communication apparatus communicates through the network;
an external address and port information transmitter that transmits the global address information and the port information of the communication apparatus toward the other communication apparatus through the network;
an external address and port information receiver that receives global address information and port information of the other communication apparatus from the other communication apparatus through the network;
a communication state determiner that determines whether a VPN communication is possible or not between the communication apparatus and the other communication apparatus, using the global address information and the port information of the other communication apparatus;
a communication data transmitter that transmits the communication data to the other communication apparatus,
a data type determiner that determines a protocol type of the communication data that is transmitted by the communication data transmitter; and
a sequence decider that decides a sequence of the determination of whether the VPN communication is possible or not by the communication state determiner and the transmission start of the communication data by the communication data transmitter based on a determination result by the data type determiner.

12. The communication apparatus according to claim 11, wherein the sequence decider decides to start the transmission of the communication data before determining whether the VPN communication is possible or not by the communication state determiner in a case where the data type determiner determines that the communication data is UDP data, and
the data transmitter starts the transmission of the communication data toward the other communication apparatus through the network before the communication state determiner determines whether the VPN communication is possible or not.

13. The communication apparatus according to claim 11, wherein the sequence decider decides to start the transmission of the communication data after determining whether the VPN communication is possible not by the communication state determiner in a case where the data type determiner determines that the communication data is TCP data, and
the data transmitter starts the transmission of the communication data toward the other communication apparatus through a communication path that is determined that the VPN communication is possible, after the communication state determiner determines whether the VPN communication is possible or not.

14. A networking method of a communication apparatus in which a virtual private network is established with another communication apparatus on a network to perform the communication, the networking method comprising:
acquiring global address information and port information of the communication apparatus that is used when the communication apparatus communicates through the network;
transmitting the global address information and the port information of the communication apparatus toward the other communication apparatus through the network;
receiving global address information and port information of the other communication apparatus from the other communication apparatus through the network;
determining whether a VPN communication is possible or not between the communication apparatus and the other communication apparatus, using the global address information and the port information of the other communication apparatus;
transmitting communication data to the other communication apparatus;
determining a protocol type of the communication data that is to be transmitted; and
deciding a sequence of the determination of whether the VPN communication is possible or not and the transmission start of the communication data based on a determination result of the protocol type of the communication data.
